(19) United States
(12) Patent Application Publication
(10) Pub. No.: US 2013/0167175 A1
(43) Pub. Date: Jun. 27, 2013

(54) ELECTRIC DEVICE AND METHOD OF CONTROLLING THE SAME

(71) Applicants: Seokbok JANG, Seoul (KR); Jungkyu CHOI, Seoul (KR); Juhee KIM, Seoul (KR); Jongse PARK, Seoul (KR); Joonyup LEE, Seoul (KR)

(72) Inventors: Seokbok JANG, Seoul (KR); Jungkyu CHOI, Seoul (KR); Juhee KIM, Seoul (KR); Jongse PARK, Seoul (KR); Joonyup LEE, Seoul (KR)

(73) Assignee: LG Electronics Inc., Seoul (KR)

(21) Appl. No.: 13/334,282

(22) Filed: Dec. 22, 2011

(51) Int. Cl. H04N 21/482

(52) U.S. Cl. 725/40

(57) ABSTRACT

An electronic device and a method of controlling the same are provided. The electronic device includes: a communication unit including a broadcasting receiver and an Internet module; and a controller for performing, when at least one broadcasting related information related to broadcasting data that can be acquired through the broadcasting receiver is included in data acquired from another electronic device through the Internet module while generating a display signal of broadcasting data acquired through the broadcasting receiver, a function according to broadcasting related information selected from the at least one broadcasting related information. Therefore, by enabling to perform a function according to specific broadcasting related information selected from broadcasting related information acquired from another electronic device, while viewing broadcasting, necessary information can be acquired and the acquired information can be easily executed.

### FIELD OF THE INVENTION

The present invention relates to an electronic device and a method of controlling the same, and more particularly, to an electronic device and a method of controlling the same that can acquire necessary information and easily execute the acquired information while viewing broadcasting by enabling to perform a function according to specific broadcasting related information selected from broadcasting related information acquired from another electronic device.

### DISCUSSION OF THE RELATED ART

As the functions of terminals such as personal computers, laptop computers, cellular phones and the like are diversified, the terminals are manufactured in the form of a multimedia player with multiple functions of shooting photos or videos; playing music, videos, and games; and receiving broadcasting programs.

A terminal as a multimedia player can be called a display device since it generally has a function of displaying video information.

Terminals can be divided into two types: a mobile and a stationary terminal. Examples of mobile terminals include laptop computers, cellular phones, etc. while examples of stationary terminals include television systems, monitors for desktop computers, etc.

### SUMMARY

An aspect of the present invention is to provide an electronic device and a method of controlling the same that can acquire necessary information and easily execute the acquired information while viewing broadcasting by enabling to perform a function according to specific broadcasting related information selected from broadcasting related information acquired from another electronic device.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 is a block diagram illustrating an electric device according to an exemplary embodiment of the present invention;

FIG. 2 is a diagram illustrating a system including the electronic device of FIG. 1;

FIG. 3 is a diagram illustrating an operation state of the electronic device of FIG. 1;

FIG. 4 is a diagram illustrating an information display area of the electronic device of FIG. 3;

FIG. 5 is a flowchart illustrating an operation process of the electronic device of FIG. 1;

FIG. 6 is a message flow diagram illustrating an operation process of a system including the electronic device of FIG. 1;

FIG. 7 is a diagram illustrating a relationship between a broadcasting server and the electronic device of FIG. 1;

FIG. 8 is a diagram illustrating a display of another electronic device of FIG. 7;

FIGS. 9 and 10 are diagrams illustrating a display of the electronic device of FIG. 7;

FIG. 11 is a diagram illustrating related information of the electronic device of FIG. 7;

FIG. 12 is a flowchart illustrating an operation process of the electronic device of FIG. 1; and

FIG. 13 is a diagram illustrating an operation state of the electronic device of FIG. 12.

### DETAILED DESCRIPTION

The present invention will now be described more fully with reference to the accompanying drawings, in which exemplary embodiments of the invention are shown. The invention may, however, be embodied in many different forms and should not be construed as being limited to the embodiments set forth herein; rather, there embodiments are provided so that this disclosure will be thorough and complete, and will fully convey the concept of the invention to those skilled in the art.

Hereinafter, a mobile terminal relating to the present invention will be described below in more detail with reference to the accompanying drawings. In the following description, suffixes “module” and “unit” are given to components of the mobile terminal in consideration of only facilitation of description and do not have meanings or functions discriminated from each other.

The mobile terminal described in the specification can include a cellular phone, a smart phone, a laptop computer, a digital broadcasting terminal, personal digital assistants (PDA), a portable multimedia player (PMP), a navigation system and so on.

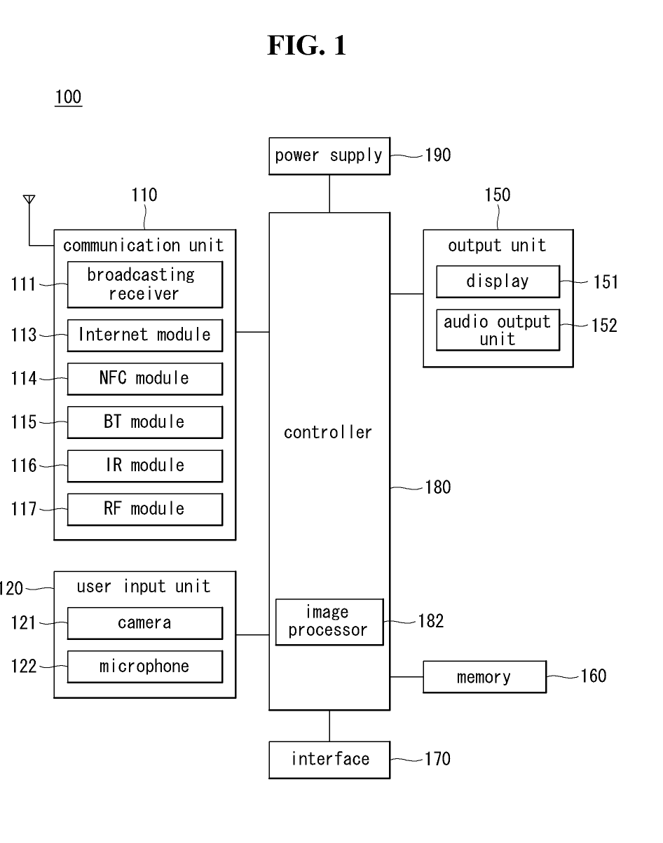

FIG. 1 is a block diagram illustrating an electric device according to an exemplary embodiment of the present invention.

As shown in the figure, an electric device 100 according to an exemplary embodiment of the present invention comprises a communication unit 110, a user input unit 120, an output unit 150, a memory 160, an interface unit 170, a controller 180, and a power supply 190. The components shown in FIG. 1 are those commonly found in an electric device; therefore, electric devices can be implemented with a larger or a smaller number of components than that of FIG. 1.

The communication unit 110 can include more than one module which enables communication between the electric device 100 and a communication system or between the electric device 100 and other devices. For example, the communication unit 110 can include a broadcasting receiver 111, an Internet module 113, a near field communication (NFC) module 114, a Bluetooth (BT) module 115, an infrared (IR) module 116, and a radio frequency (RF) module 117.

The broadcasting receiver 111 receives a broadcasting signal and/or broadcasting related information from an external broadcasting management server through a broadcasting channel.

The broadcasting channels can include a satellite and a terrestrial channel. The broadcasting management server can indicate a server generating and transmitting broadcasting signals and/or broadcasting related information; or a server receiving broadcasting signals and/or broadcasting related information and transmitting them to terminals. The broadcasting signals include TV broadcasting signals, radio broadcasting signals, and data broadcasting signals. Furthermore, the broadcasting signal can further include such a broadcasting signal in the form of a combination of a TV broadcasting signal or a radio broadcasting signal with a data broadcasting signal.

The broadcasting related information can correspond to the information related to broadcasting channels, broadcasting programs, or broadcasting service providers. The broadcasting related information can also be provided through a communication network.

The broadcasting related information can be provided in various forms. For example, the broadcasting related information can be provided in the form of EPG (Electronic Program Guide) of DMB (Digital Multimedia Broadcasting) or ESG (Electronic Service Guide) of DVB-H (Digital Video Broadcast-Handheld).

The broadcasting receiver 111 can receive broadcasting signals by using various broadcasting systems. The broadcasting signal and/or broadcasting related information received through the broadcasting receiver 111 can be stored in the memory 160.

The Internet module 113 is a module for connecting to the Internet. The Internet module 113 can be installed inside or outside the electric device 100.

The NFC (Near Field Communication) module 114 is a module carrying out communication according to NFC protocol. The NFC module 114 can commence communication through tagging motion for NFC devices and/or NFC tags. For example, if an electronic device with NFC function is tagged to the electric device 100, it indicates that an NFC link can be established between the electronic device and the electric device 100. The electronic device and the electric device 100 can transmit and receive necessary information to and from each other through the established NFC link.

The Bluetooth module 115 is a module carrying out communication according to Bluetooth protocol. The Bluetooth module 115 carries out communication based on short range wireless networking technology co-developed by Bluetooth SIG (Special Interest Group). By using the Bluetooth module 115, the electric device 100 can carry out Bluetooth communication with other electronic devices.

The infrared module 116 is a module carrying out communication by using infrared rays.

The radio frequency (RF) module 117 is a module carrying out wireless communication with the electric device 100. The RF module 177 can employ a communication technology different from the other communication modules mentioned earlier.

The user input module 120 is used for inputting audio or video signals, which can include a camera 121, a microphone 122, etc.

The camera 121 processes image frames such as photos or videos obtained by an image sensor at video telephony mode or shooting mode. The image frames processed can be displayed on the display unit 151. The camera 121 can correspond to a camera 121 capable of 2D or 3D imaging, where the camera 121 can consists of a single 2D or 3D camera or a combination of both.

Image frames processed by the camera 121 can be stored in the memory 160 or transmitted to the outside through the communication unit 110. Depending on the configuration of the electric device 100, two or more cameras 121 can be installed.

The microphone 122 receives external sound signals and transforms the received signals to voice data in the telephony mode, recording mode, or voice recognition mode. The microphone 122 can employ various noise suppression algorithms to remove noise generated while external sound signals are received.

The output unit 150 can include a display unit 151 and an audio output unit 152.

The display unit 151 displays information processed within the electric device 100. For example, the display unit 151 displays an UI (User Interface) or a GUI (Graphic User Interface) related to the electric device 100. The display unit 151 can employ at least one from among liquid crystal display, thin film transistor-liquid crystal display, organic light-emitting diode, flexible display, and 3D display. In addition, the display unit 151 can be implemented in the form of a transparent or light-transmission type display, which can be called a transparent display. A typical example of a transparent display is a transparent LCD. The rear structure of the display unit 151 can also employ the light-transmission type structure. Thanks to the above structure, the user can see objects located in the back of the terminal body through the area occupied by the display unit 151 of the body.

Depending on how the electric device 100 is implemented, two or more display units 151 can exist. For example, in the electric device 100, multiple display units 151 can be disposed being separated from each other or as a whole body in a single area; alternatively, the multiple display units 151 can be disposed respectively in different areas from each other.

In the case where the display unit 151 and a sensor detecting a touch motion (hereinafter, it is called a ‘touch sensor’) form a mutual structure between them (hereinafter, it is called a ‘touch screen’), the display unit 151 can also be used as an input device in addition to an output device. The touch sensor can take the form of a touch film, a touch sheet, and a touch pad, for example.

A touch sensor can be formed in such a way to transform the change of pressure applied to a particular part of the display unit 151 or the change of capacitance generated at a particular part of the display unit 151 into the corresponding electric signal. The touch sensor can be so fabricated to detect the pressure at the time of touch motion as well as the touch position and area.

When a touch input is applied to the touch sensor, a signal corresponding to the touch input is forwarded to a touch controller. The touch controller processes the signal and transfers the data corresponding to the signal to the controller 180. In this way, the controller 180 can know which area of the display unit 151 has been touched.

The audio sound unit 152 can output audio data received from the communication unit 110 or stored in the memory 160. The audio sound unit 152 can output sound signals related to the functions carried out in the electric device 100 (for example, a call signal receiving sound and a message receiving sound). The audio output unit 152 can comprise a receiver, a speaker, and a buzzer.

The memory 160 can store programs specifying the operation of the controller 180 and temporarily store input/output data (for example, a phonebook, a message, a still image, and a video). The memory 160 can store data related to various patterns of vibration and sound generated at the time of touch input on the touch screen.

The memory 160 can be realized by at least one type of storage media including flash type memory, hard disk, multimedia card micro memory, card type memory (e.g., SD or XD memory), RAM (Random Access Memory), SRAM (Static Random Access Memory), ROM (Read-Only Memory), EEPROM (Electrically Erasable Programmable Read-Only Memory), PROM (Programmable Read-Only Memory), magnetic memory, magnetic disk, and optical disk. The electric device 100 can function in association with a web storage which can perform a storage function of the memory 160 on the Internet.

The interface unit 170 serves as a passage to all the external devices connected to the electric device 100. The interface unit 170 receives data from external devices or receives power and delivers the received data and power to each of constituting components within the electric device 100 or transmits the data within the electric device 100 to external devices. For example, the interface unit 170 can include a wired/wireless headset port, an external charger port, a wired/wireless data port, a memory card port, a port connecting a device equipped with an identification module, an audio I/O (Input/Output) port, a video I/O port, and an earphone port.

The controller 180 usually controls the overall operation of the electric device. For example, the controller 180 carries out control and processing for voice, data, and video communication. The controller 180 can be equipped with an image processor 182 for processing images. Description of the image processor 182 will be provided more specifically in the corresponding part of this document.

The power supply 190 receives external and internal power according to the control of the controller 180 and provides power required for the operation of each constituting component.

Various embodiments described in this document can be implemented in a computer or in a recording medium readable by a device similar to the computer, both of which utilizing software, hardware, or a combination of software and hardware. As for hardware implementation, the embodiment of this document can be implemented by using at least one of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), processors, controllers, micro-controllers, micro-processors, and electric units for carrying out functions. In some cases, the embodiments can be implemented by the controller 180.

As for software implementation, embodiments such as procedures or functions can be implemented together with separate software modules supporting at least one function or operation. Software codes can be implemented by a software application written by a relevant programming language. Also, software codes can be stored in the memory 160 and carried out by the controller 180.

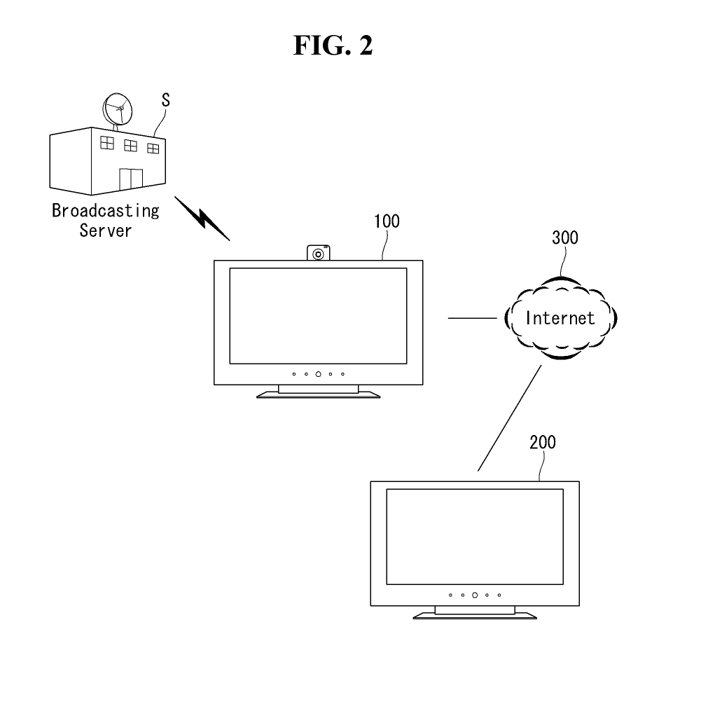

FIG. 2 is a diagram illustrating a system including the electronic device of FIG. 1.

As shown in FIG. 2, the electronic device 100 according to an exemplary embodiment of the present invention receives and outputs broadcasting data from a broadcasting server S.

The broadcasting server S transmits broadcasting data of various channels. Broadcasting data of the broadcasting server S may be transmitted with a wired and/or wireless method(s).

The electronic device 100 can communicate with another electronic device 200 through Internet 300. For example, the electronic device 100 may acquire and display broadcasting related information input by a user of the another electronic device 200 through the Internet 300.

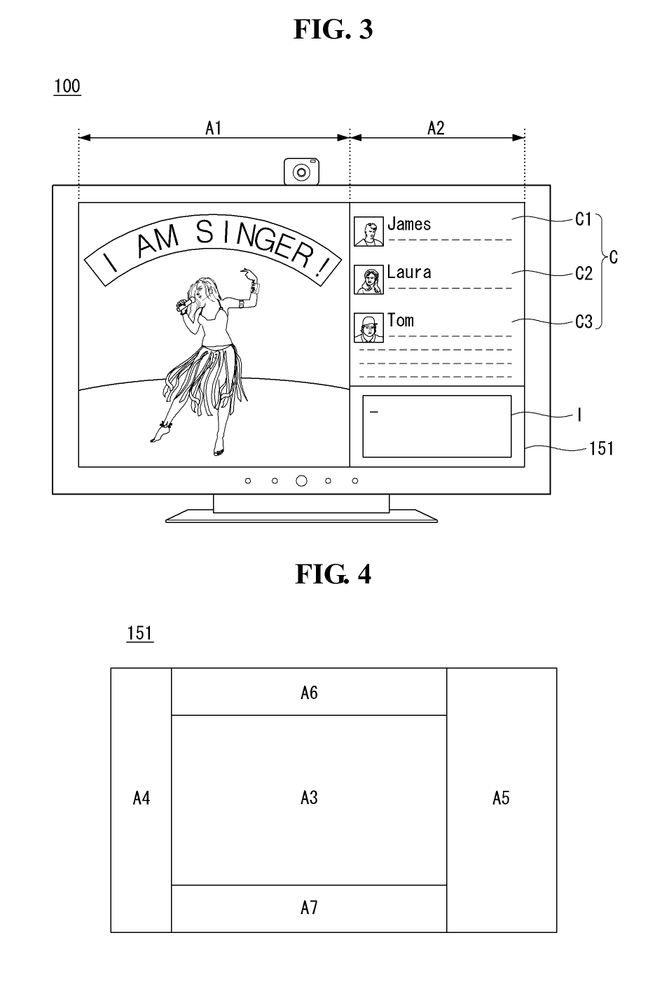

FIG. 3 is a diagram illustrating an operation state of the electronic device of FIG. 1.

As shown in FIG. 3, the display 151 of the electronic device 100 according to an exemplary embodiment of the present invention is partitioned into a broadcasting area A1 and an information area A2. However, the electronic device 100 may have no display 151. For example, the electronic device 100 may acquire broadcasting data from the broadcasting server (S of FIG. 2) and output the broadcasting data to an external display 151, as in a set top box.

The broadcasting area A1 may be an area for displaying broadcasting data acquired from the broadcasting server S. For example, broadcasting of a specific channel selected by the user may be displayed in the broadcasting area A1.

The information area A2 may be an area for displaying information acquired through Internet (300 of FIG. 2). The information acquired through the Internet 300 may be information acquired through a social network service (SNS). For example, the information acquired through the Internet 300 may be information acquired through a specific SNS in which a user of the electronic device 100 joins or may be information acquired from another user directly networked to the user of the electronic device 100.

Various network information C may be displayed in the information area A2. As described above, the network information C may be information acquired through the SNS.

The network information C may include first to third network information C1 to C3 written by a user of the another electronic device 100. The first to third network information C1 to C3 may be a message written by other users viewing broadcasting. For example, the first to third network information C1 to C3 may be viewing impressions of a specific program telecasted in a specific channel.

An input window I may be displayed in the information area A2. The user can input his opinion about a specific program telecasted in a specific channel through the input window I. That is, the user of the electronic device 100 can exchange an opinion with another user through the information area A2.

FIG. 4 is a diagram illustrating an information display area of the electronic device of FIG. 3.

As shown in FIG. 4, the electronic device 100 according to an exemplary embodiment of the present invention can display broadcasting data and network information in a selected specific area of the display 151.

The controller (180 of FIG. 1) partitions the display 151 into a plurality of areas. For example, the controller 180 may partition the display 151 into areas A3 to A7.

The controller 180 controls to display broadcasting data and network information in a specific area based on a partitioned area. For example, the controller 180 may control to integrate areas A3, A4, A6, and A7, to display broadcasting data in the areas A3, A4, A6, and A7, and to display network information in an area A5. Alternatively, the controller 180 may control to display network information in a specific area of areas A4, A5, A6, and A7 and to display broadcasting data in other areas. Such display of broadcasting data and network information may be automatically adjusted by the controller 180 or may be changed by a user's setting according to a state of broadcasting data and/or network information received at that time.

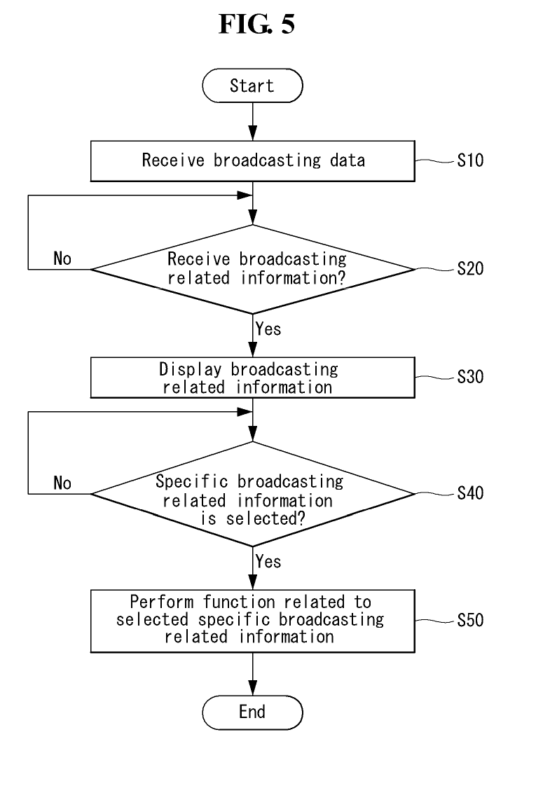

FIG. 5 is a flowchart illustrating an operation process of the electronic device of FIG. 1.

As shown in FIG. 5, the controller 180 of the electronic device 100 according to an exemplary embodiment of the present invention receives broadcasting data (S10).

As described above, broadcasting data are received from the broadcasting server S.

The controller 180 determines whether broadcasting related information is received (S20), and if broadcasting related information is received, the controller 180 controls to display the received broadcasting related information (S30).

The broadcasting related information may further include additional information for enabling to directly perform operation related to a specific channel and/or a specific program among network information acquired through the Internet (300 of FIG. 2). For example, the broadcasting related information may be information for enabling to change a channel from a present channel to another specific channel and information about a broadcasting time and contents of a specific channel and/or program.

The broadcasting related information may be information in which a user of another electronic device 200 generates and transmits. For example, the broadcasting related information may be information in which the user of another electronic device 200, having viewed a specific channel transmits to a user of the electronic device 100 wishing to view together the specific channel. When the broadcasting related information is received, the controller 180 controls the display 151 to display the broadcasting related information.

The controller 180 determines whether specific broadcasting related information is selected (S40), and if specific broadcasting related information is selected, the controller 180 performs a function related to the selected specific broadcasting related information (S50).

As described above, the broadcasting related information includes information for enabling to convert to a specific another channel. Therefore, when the user of the electronic device 100 selects the information, the controller 180 immediately performs a function according to the selected broadcasting related information. Therefore, it is unnecessary to perform a separate function in order to convert a channel. Further, because the user of the electronic device 100 can exchange various broadcasting related information with a user of another electronic device 200, desired information can be conveniently and quickly exchanged.

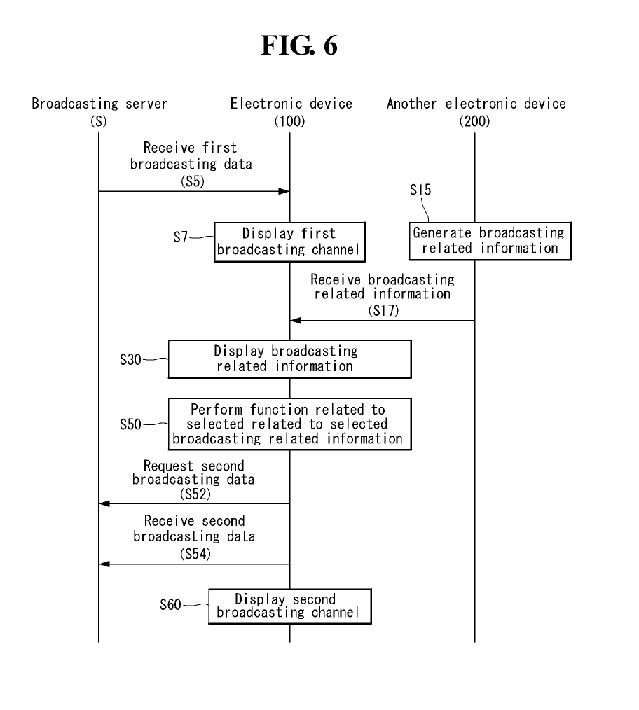

FIG. 6 is a message flow diagram illustrating an operation process of a system including the electronic device of FIG. 1.

As shown in FIG. 6, the electronic device 100 according to an exemplary embodiment of the present invention can acquire broadcasting related information from the another electronic device 200 and receive and display necessary broadcasting data.

The electronic device 100 receives first broadcasting data from the broadcasting server S (S5) and displays a first broadcasting channel according to the received first broadcasting data (S7).

The another electronic device 200 generates and transmits broadcasting related information (S15).

The electronic device 100 receives broadcasting related information from the another electronic device 200 while displaying the first broadcasting channel (S17).

The electronic device 100 displays the received broadcasting related information (S30). When the broadcasting related information is displayed, the user can know that specific broadcasting related information is received from a specific user.

The controller 180 may control to selectively display broadcasting related information in which a specific content is included. For example, the controller 180 may control to selectively filter and display only broadcasting related information including a word previously set by the user.

The controller 180 performs a function related to the selected broadcasting related information (S50). When the broadcasting related information is displayed, the user can select the displayed broadcasting related information. For example, the user may perform a function of changing from a presently viewing broadcasting channel to a specific broadcasting channel provided by another user.

When a channel change is selected, the electronic device 100 requests second broadcasting data to the broadcasting server S (S52) and receives the second broadcasting data from the broadcasting server S (S54).

The electronic device 100 display a second broadcasting channel according to the received second broadcasting data (S60).

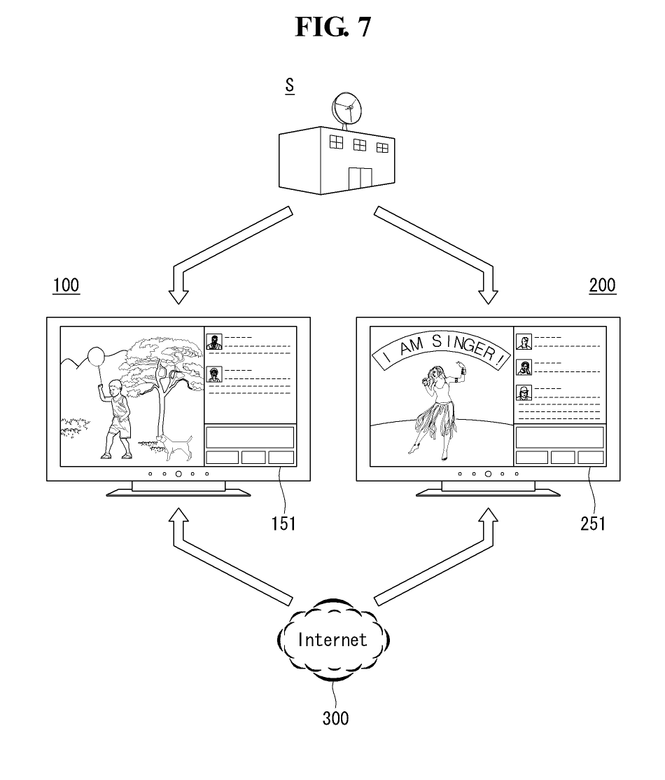

FIG. 7 is a diagram illustrating a relationship between a broadcasting server and the electronic device of FIG. 1.

As shown in FIG. 7, the another electronic device 200 and the electronic device 100 according to an exemplary embodiment of the present invention display a broadcasting channel corresponding to broadcasting data received from the broadcasting server S.

The electronic device 100 and the another electronic device 200 may receive and display different broadcasting channels.

The electronic device 100 and the another electronic device 200 may be in a state that can exchange information through the Internet 300. The electronic device 100 and the another electronic device 200 may be in a state that can exchange network information including broadcasting related information through an SNS.

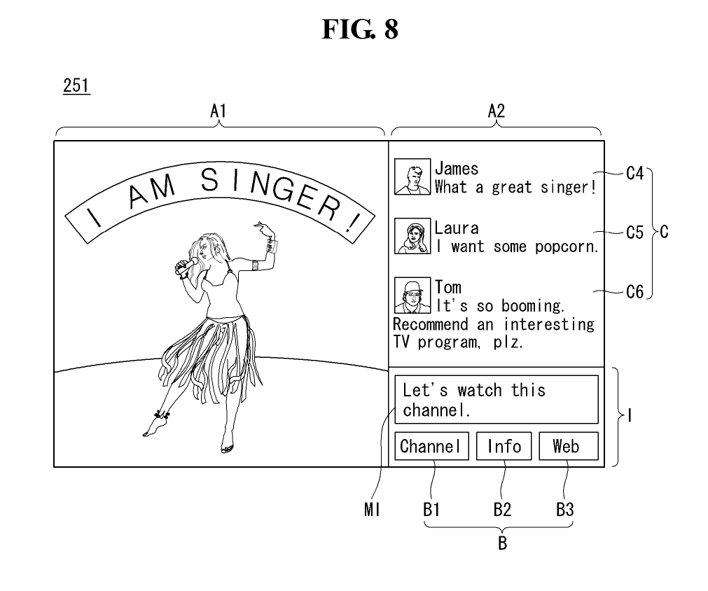

FIG. 8 is a diagram illustrating a display of another electronic device of FIG. 7.

As shown in FIG. 8, a specific broadcasting channel may be displayed in a first area A1 of a display 251 of another electronic device according to an exemplary embodiment of the present invention.

Various network information C may be displayed in a second area A2 of the display 251 of the another electronic device. The network information C may include various information in which users viewing the same broadcasting channel or different broadcasting channels exchange.

A user of the another electronic device can input a message wishing to transmit to another user through an input window I. For example, the user of the another electronic device may input a recommendation message of a broadcasting channel wishing to view together with another user.

A related information button B that can add broadcasting related information may be positioned at the input window I. The user can add specific broadcasting related information to a message in which the user himself inputs with a method of selecting a specific button of the related information buttons B.

The related information button B includes a first button B1 related to a function that can change a channel, a second button B2 related to a function that can display broadcasting information, and a third button B3 related to a function that can display a web page that can search for information related to a specific broadcasting channel. However, the first to third buttons B1 to B3 displayed in the drawings are an example and the kind and/or the number of the button are not limited thereto.

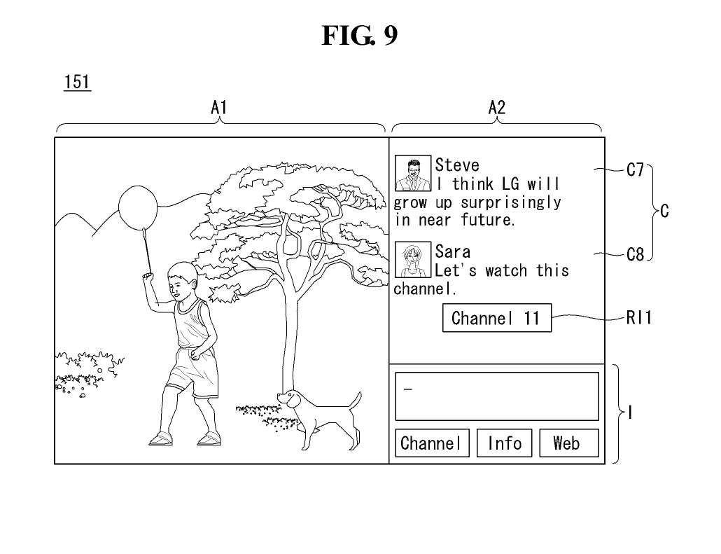

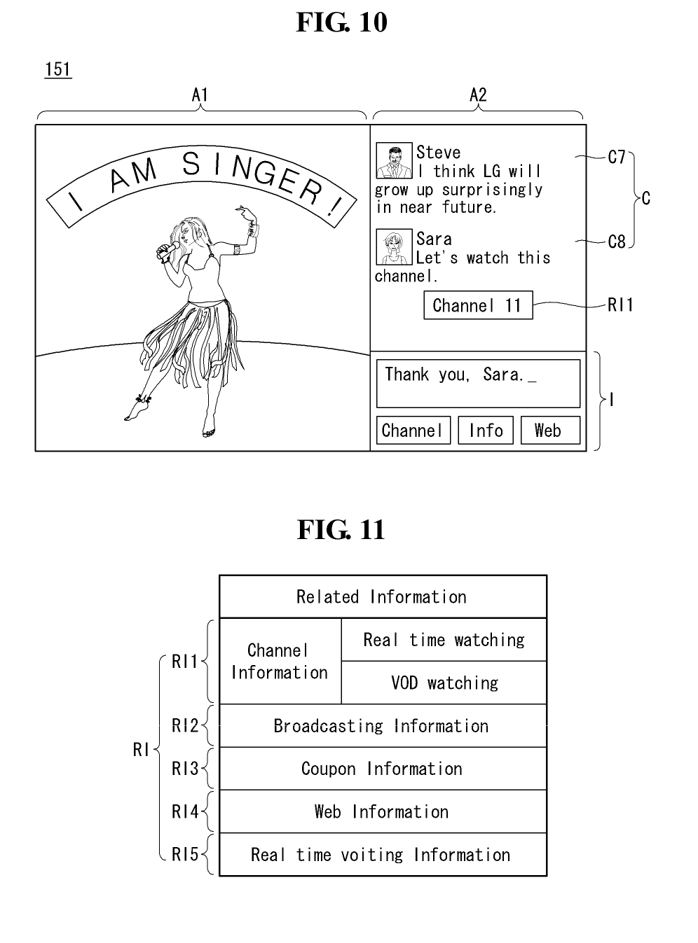

FIGS. 9 and 10 are diagrams illustrating a display of the electronic device of FIG. 7.

As shown in FIG. 9, a specific broadcasting channel may be displayed in the first area A1 of the display 151 of an electronic device according to an exemplary embodiment of the present invention. Various network information C may be displayed in the second area A2.

Eighth network information C8 transmitted from Sara, who is a user of the another electronic device 200 may be included in the network information C. First broadcasting related information RI1 may be included in the eighth network information C8.

The received first broadcasting related information RI1 includes information in which Sara, who is a user of the another electronic device 200 can directly connect her channel to a channel recommended by the user of the electronic device 100.

As shown in FIG. 10, when the user of the electronic device 100 selects the received broadcasting related information RI1, a broadcasting channel according to corresponding broadcasting related information is displayed in the display 151. That is, by selecting information displayed while chatting with users of the another electronic device 200, even if a separate another menu is not selected, the broadcasting channel can be changed to a specific broadcasting channel. Therefore, the user can smoothly perform a message exchange with another user while viewing broadcasting.

The user can transmit a message to Sara, having transmitted the broadcasting related information RI1 through the input window I.

FIG. 11 is a diagram illustrating related information of the electronic device of FIG. 7.

As shown in FIG. 11, the electronic device 100 according to an exemplary embodiment of the present invention includes various broadcasting related information.

The first broadcasting related information RI1 is related to a function of displaying broadcasting in real time and/or in a video on demand (VOD) method.

Second broadcasting related information RI2 is related to a function of displaying information of a specific broadcasting program. For example, the second broadcasting related information RI2 may be related to a function of displaying information such as a title, contents, a start time, an end time, and actors of a specific broadcasting program.

Third broadcasting related information RI3 is related to a function of displaying coupon information. For example, the third broadcasting related information RI3 may be related to a function of giving a coupon necessary for viewing a pay specific broadcasting program to a user.

Fourth broadcasting related information RI4 is related to a function that can connect to a web page that can acquire information of a specific broadcasting program. For example, when the user of the electronic device 100 selects the fourth broadcasting related information RI4, the user can connect to a web page that can display information about a corresponding broadcasting channel.

A fifth broadcasting related information RI5 is related to a function that can perform a vote in real time. For example, the fifth broadcasting related information RI5 may be information that can participate in a vote that determines ranking in a broadcasting program that determines ranking.

By selecting information appropriate for a situation from broadcasting related information and transmitting the information to another user, while viewing broadcasting, information can be effectively exchanged.

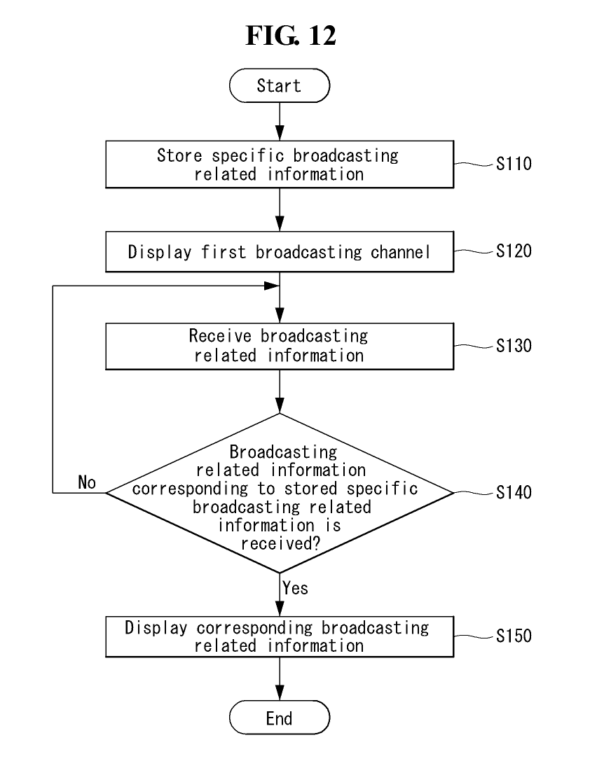

FIG. 12 is a flowchart illustrating an operation process of the electronic device of FIG. 1.

As shown in FIG. 12, the controller 180 of the electronic device 100 according to an exemplary embodiment of the present invention stores specific broadcasting related information (S110).

Specific broadcasting related information may be a keyword in which the user of the electronic device 100 is to search for. For example, a user interested in an island “Dokdo” may store the island “Dokdo” as a keyword.

The controller 180 controls to display the first broadcasting channel (S120).

When broadcasting related information is received (S130), the controller 180 determines whether broadcasting related information corresponding to stored specific broadcasting related information is received (S140).

Broadcasting related information may be received with various subjects. Information in which the user is interested may be included in broadcasting related information of various subjects. The user can previously store a keyword of interested information, and the controller 180 determines whether information corresponding to a keyword previously stored by the user exists in the received broadcasting related information.

The controller 180 controls to display corresponding broadcasting related information (S150)

When information corresponding to a keyword stored as an interested keyword by the user of the electronic device 100 is received, the controller 180 controls to display corresponding broadcasting related information. Therefore, even if the user does not continue to view received broadcasting related information, the user can easily recognize desired broadcasting related information.

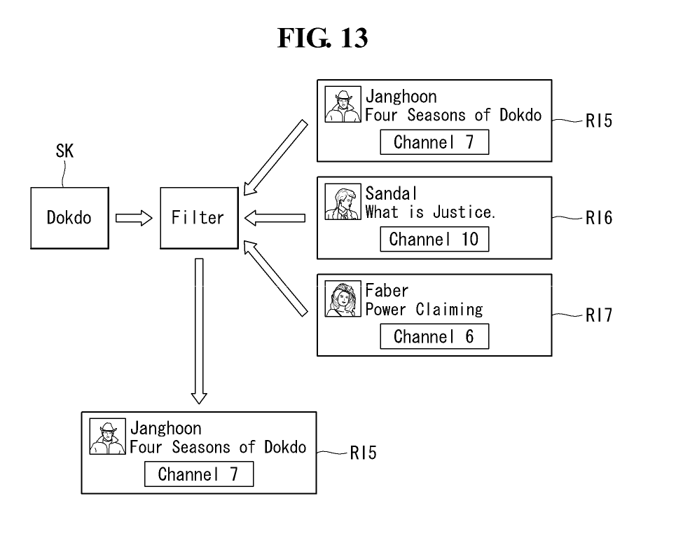

FIG. 13 is a diagram illustrating an operation state of the electronic device of FIG. 12.

As shown in FIG. 13, the electronic device 100 according to an exemplary embodiment of the present invention compares a keyword SK previously stored at the memory (160 of FIG. 1) by the user and received fifth to seventh broadcasting related information RI5 to RI7. For example, by forming a specific filter, the electronic device 100 may compare the keyword SK and the received fifth to seventh broadcasting related information RI5 to RI7.

When the keyword SK is included in the fifth broadcasting related information RI5, the controller 180 controls to display the fifth broadcasting related information RI5. Therefore, the user can selectively view only desired information.

Although exemplary embodiments of the present invention have been described in detail hereinabove, it should be clearly understood that many variations and modifications of the basic inventive concepts herein described, which may appear to those skilled in the art, will still fall within the spirit and scope of the exemplary embodiments of the present invention as defined in the appended claims.

What is claimed is:

1. An electronic device comprising:
a broadcasting receiver configured to receive broadcasting data;
a network module configured to acquire broadcasting related information; and
a controller configured to:
access broadcasting data received through the broadcasting receiver;
control output of the accessed broadcasting data through an output device;
during output of the accessed broadcasting data through the output device, access broadcasting related information acquired through the network module from a remote electronic device;
select, from the accessed broadcasting related information, specific broadcasting related information that relates to the accessed broadcasting data; and
perform a function based on the specific broadcasting related information selected.

2. The electronic device of claim 1:
wherein the controller is configured to access broadcasting data received through the broadcasting receiver by accessing a broadcasting program received through the broadcasting receiver;
wherein the controller is configured to control output of the accessed broadcasting data through the output device by controlling display of the broadcasting program on a display device;
wherein the controller is configured to access broadcasting related information acquired through the network module from the remote electronic device by accessing messages acquired through the network module from a social network service;
wherein the controller is configured to select, from the accessed broadcasting related information, specific broadcasting related information that relates to the accessed broadcasting data by selecting, from the accessed messages acquired through the network module from the social network service, at least one message related to the broadcasting program.

3. The electronic device of claim 1:
wherein the controller is further configured to control display of the broadcasting related information; and
wherein the controller is configured to select, from the accessed broadcasting related information, specific broadcasting related information that relates to the accessed broadcasting data by receiving user input that selects a portion of the displayed broadcasting related information and selecting the specific broadcasting related information based on the user input.

4. The electronic device of claim 1:
wherein the controller is configured to access broadcasting data received through the broadcasting receiver by accessing first broadcasting data;
wherein the controller is configured to control output of the accessed broadcasting data through the output device by controlling output of the first broadcasting data through the output device; and
wherein the controller is configured to access broadcasting related information acquired through the network module from the remote electronic device by accessing information that relates to receiving second broadcasting data through the broadcasting receiver, the second broadcasting data being different from the first broadcasting data.

5. The electronic device of claim 4:
wherein the controller is configured to select, from the accessed broadcasting related information, specific broadcasting related information that relates to the accessed broadcasting data by selecting the information that relates to receiving second broadcasting data through the broadcasting receiver; and
wherein the controller is configured to perform the function based on the specific broadcasting related information selected by controlling the broadcasting receiver to receive the second broadcasting data, accessing the second broadcasting data received through the broadcasting receiver, and controlling output of the second broadcasting data through the output device.

6. The electronic device of claim 1, wherein the controller is configured to access broadcasting related information acquired through the network module from the remote electronic device by accessing at least one of information about a broadcasting program represented by the accessed broadcasting data, information about a web page that hosts information about the accessed broadcasting data, and information about a use right for receiving the broadcasting data.

7. The electronic device of claim 6, accessing at least one of information about a broadcasting program represented by the accessed broadcasting data, information about a web page that hosts information about the accessed broadcasting data, and information about a use right for receiving the broadcasting data comprises accessing information about a broadcasting program represented by the accessed broadcasting data.

8. The electronic device of claim 6, accessing at least one of information about a broadcasting program represented by the accessed broadcasting data, information about a web page that hosts information about the accessed broadcasting data, and information about a use right for receiving the broadcasting data comprises accessing information about a web page that hosts information about the accessed broadcasting data.

9. The electronic device of claim 6, accessing at least one of information about a broadcasting program represented by the accessed broadcasting data, information about a web page that hosts information about the accessed broadcasting data, and information about a use right for receiving the broadcasting data comprises accessing information about a use right for receiving the broadcasting data.

10. The electronic device of claim 1, further comprising a memory configured to store at least one keyword,
wherein the controller is configured to select, from the accessed broadcasting related information, specific broadcasting related information that relates to the accessed broadcasting data by:
accessing, from the memory, a keyword;
comparing the accessed keyword with the accessed broadcasting related information; and
selecting the specific broadcasting related information based on the comparison.

11. The electronic device of claim 10, wherein selecting the specific broadcasting related information based on the comparison comprises identifying at least one entry within the accessed broadcasting related information that includes the accessed keyword,
wherein the controller is configured to control display of the identified at least one entry within the accessed broadcasting related information that includes the accessed keyword.

12. The electronic device of claim 1, wherein the controller is configured to:
determine a state of the accessed broadcasting data; and
change a display area of the accessed broadcasting data and the accessed broadcasting related information according to the determined state of the accessed broadcasting data.

13. The electronic device of claim 1, wherein the controller is configured to:
determine a state of the accessed broadcasting related information; and
change a display area of the accessed broadcasting data and the accessed broadcasting related information according to the determined state of the accessed broadcasting related information.

14. A method of controlling an electronic device, the method comprising:
accessing broadcasting data received through a broadcasting receiver;
controlling output of the accessed broadcasting data through an output device;
during output of the accessed broadcasting data through the output device, accessing broadcasting related information acquired through a network module from a remote electronic device;
selecting, from the accessed broadcasting related information, specific broadcasting related information that relates to the accessed broadcasting data; and
performing a function based on the specific broadcasting related information selected.

15. The method of claim 14:
wherein accessing broadcasting data received through the broadcasting receiver comprises accessing a broadcasting program received through the broadcasting receiver;
wherein controlling output of the accessed broadcasting data through the output device comprises controlling display of the broadcasting program on a display device;
wherein accessing broadcasting related information acquired through the network module from the remote electronic device comprises accessing messages acquired through the network module from a social network service;
wherein selecting, from the accessed broadcasting related information, specific broadcasting related information that relates to the accessed broadcasting data comprises selecting, from the accessed messages acquired through the network module from the social network service, at least one message related to the broadcasting program.

16. The method of claim 14, further comprising:
controlling display of the broadcasting related information,
wherein selecting, from the accessed broadcasting related information, specific broadcasting related information that relates to the accessed broadcasting data comprises receiving user input that selects a portion of the displayed broadcasting related information and selecting the specific broadcasting related information based on the user input.

17. The method of claim 14:
wherein accessing broadcasting data received through the broadcasting receiver comprises accessing first broadcasting data;
wherein controlling output of the accessed broadcasting data through the output device comprises controlling output of the first broadcasting data through the output device; and
wherein accessing broadcasting related information acquired through the network module from the remote electronic device comprises accessing information that relates to receiving second broadcasting data through the broadcasting receiver, the second broadcasting data being different from the first broadcasting data.

18. The method of claim 14, wherein accessing broadcasting related information acquired through the network module from the remote electronic device comprises accessing at least one of information about a broadcasting program represented by the accessed broadcasting data, information about a web page that hosts information about the accessed broadcasting data, and information about a use right for receiving the broadcasting data.

19. The method of claim 14, wherein selecting, from the accessed broadcasting related information, specific broadcasting related information that relates to the accessed broadcasting data comprises:
accessing, from memory, a keyword;
comparing the accessed keyword with the accessed broadcasting related information; and
selecting the specific broadcasting related information based on the comparison.

20. The method of claim 14, further comprising:
determining a state of at least one of the accessed broadcasting data and the accessed broadcasting related information; and
changing a display area of the accessed broadcasting data and the accessed broadcasting related information according to the determined state of at least one of the accessed broadcasting data and the accessed broadcasting related information.
